(19) United States
(12) Patent Application Publication
(10) Pub. No.: US 2022/0410123 A1
(43) Pub. Date: Dec. 29, 2022

(54) AIR FILTER MEDIA

(71) Applicant: Dow Global Technologies LLC, Midland, MI (US)

(72) Inventors: Jiguang Zhang, Shanghai (CN); Jian Zou, Shanghai (CN); Hongyu Chen, Zhangjiang (CN); Xuemei Zhai, Shanghai (CN); Shuyu Duan, Shanghai (CN)

(73) Assignee: Dow Global Technologies LLC, Midland, MI (US)

(21) Appl. No.: 17/780,267

(22) PCT Filed: Dec. 23, 2019
(86) PCT No.: PCT/CN2019/127387

§ 371 Date: May 26, 2022

(51) Int. Cl. B01J 20/28; B01D 39/16; B01D 53/02; B01J 20/26; B01J 20/32

(52) U.S. Cl. CPC B01J 20/28038; B01D 39/1623; B01D 39/1661; B01D 53/02; B01J 20/267; B01J 20/28057; B01J 20/3223; B01J 20/28004; B01J 20/28016; B01D 2239/0407; B01D 2239/0478; B01D 2239/0485; B01D 2239/0622; B01D 2239/0627; B01D 2239/0668; B01D 2239/0681; B01D 2239/10; B01D 2239/1241; B01D 2239/1291; B01D 2253/202; B01D 2253/25; B01D 2257/702; B01D 2258/06; B01D 2259/4508; B01D 2239/04

(57) ABSTRACT

Air filter media comprising at least one active bead layer comprises an antistatic agent and polyethylenimine coated polymeric beads that can provide better formaldehyde abatement properties than incumbent activated carbon filters and can be prepared by using existing processing facilities for manufacture of incumbent activated carbon filters.

### FIELD OF THE INVENTION

The present invention relates to air filter media and a process for preparing the same.

### INTRODUCTION

Aldehyde abatement materials are desirable in many applications such as gas filter devices. High efficiency particulate air (HEPA) filters comprising activated carbon as a filter medium are widely used as filter media for air purifiers. Fabrication of these HEPA filters typically include the steps of providing a nonwoven fabric, applying activated carbon on the fabric, spraying hot-melt adhesive materials to coat activated carbon, and further laminating with another nonwoven fabric so that activated carbon resides between the two fabrics. Inhomogeneity in coating of aldehyde abatement materials such as activated carbon may result in poor aldehyde abatement performance. Formaldehyde abatement rate and capacity are key properties for air purifier applications. Moreover, air filter media with low or even no odor are desirable.

There is a need to develop novel air filter media that afford better aldehyde abatement properties than activated carbon filters and a process for preparing the air filter media with limited impacts on existing processing facilities of incumbent air filter media.

### SUMMARY OF THE INVENTION

The present invention provides a novel air filter medium comprising one or more novel active bead layers comprising specific polyethylenimine coated polymeric beads. The air filter medium of the present invention can provide better formaldehyde abatement properties than incumbent activated carbon filters. The air filter medium of the present invention can be made by using existing processing facilities used in manufacture of incumbent activated carbon filters without the requirements of equipment modification.

In a first aspect, the present invention provides an air filter medium comprising a first nonwoven fabric, a second nonwoven fabric, and at least one active bead layer residing between the first and second nonwoven fabrics; wherein the active bead layer is attached to at least one of the first and second nonwoven fabrics by an adhesive material;

wherein the active bead layer comprises an antistatic agent and polyethylenimine coated polymeric beads having a number average particle size of 340 μm to 680 μm and a specific surface area in the range of from 20 to 400 m²/g;

wherein the polyethylenimine coated polymeric beads comprise, by weight based on the weight of the polyethylenimine coated polymeric beads, from 35% to 75% of structural units of an acetoacetoxy or acetoacetamide functional monomer and from 25% to 65% of structural units of a polyvinyl monomer; and wherein the polyethylenimine has a number average molecular weight of 300 g/mol or more.

In a second aspect, the present invention provides a process for preparing the air filter medium of the first aspect. The process comprises:

(i) providing a first nonwoven fabric;

(ii) applying an admixture of polyethylenimine coated polymeric beads and an antistatic agent to the first nonwoven fabric to form an active bead layer,

wherein the polyethylenimine coated polymeric beads with a number average particle size of 340 μm to 680 μm and a specific surface area in the range of from 20 to 400 m²/g comprise, by weight based on the weight of the polyethylenimine coated polymeric beads, from 35% to 75% of structural units of an acetoacetoxy or acetoacetamide functional monomer and from 25% to 65% of structural units of a polyvinyl monomer; and wherein the polyethylenimine has a number average molecular weight of 300 g/mol or more;

(iii) spraying an adhesive material onto the active bead layer; and

(iv) laminating a second nonwoven fabric to the first nonwoven fabric with the active bead layer residing therebetween.

### DETAILED DESCRIPTION OF THE INVENTION

“Acrylic” as used herein includes (meth)acrylic acid, alkyl (meth)acrylate, (meth)acrylamide, (meth)acrylonitrile and their modified forms such as hydroxyalkyl (meth)acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

A “bead” is characterized by its average particle size of at least 20 micrometers (μm). The average particle size herein refers to the number average particle size determined by the test method described in the Examples section below.

“Polyethylenimine coated polymeric beads” herein means at least a portion of the surface of polymeric beads is coated by a polyethylenimine.

The term “structural units” used herein, also known as polymerized units, of the named monomer refers to the remnant of the monomer after polymerization. For example, a structural unit of methyl methacrylate is as illustrated:

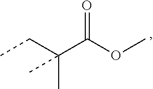

where the dotted lines represent the points of attachment of the structural unit to the polymer backbone.

The present invention provides an air filter medium, typically a multilayer structure. The air filter medium of the present invention may comprise a first nonwoven fabric, at least one active bead layer, and a second nonwoven fabric, wherein the active bead layer resides between the first nonwoven fabric and the second nonwoven fabric. The active bead layer is attached to one or both of the first nonwoven fabric and the second nonwoven fabric by an adhesive material. In some embodiments, the air filter medium of the present invention comprises two or more active bead layers, where the two or more active bead layers reside between the first and second nonwoven fabrics.

The active bead layer in the air filter medium may comprise polyethylenimine coated polymeric beads and one or more antistatic agents. The polyethylenimine coated polymeric beads useful in the present invention comprise a polymerization product of monomers comprising from 35% to 75% of at least one acetoacetoxy or acetoacetamide functional monomer and from 25% to 65% of at least one polyvinyl monomer, by weight based on the total weight of monomers.

The polyethylenimine coated polymeric beads useful in the present invention comprise structural units of one or more acetoacetoxy or acetoacetamide functional monomers. The acetoacetoxy or acetoacetamide functional monomers are monomers having one or more acetoacetyl functional groups represented by:

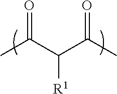

wherein R¹ is hydrogen, an alkyl having 1 to 10 carbon atoms, or phenyl.

Examples of suitable acetoacetoxy or acetoacetamide functional groups include

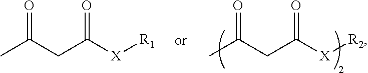

wherein X is O or N, R₁ is a divalent radical and R₂ is a trivalent radical, that attach the acetoacetoxy or acetoacetamide functional group to the backbone of a polymer.

The acetoacetoxy or acetoacetamide functional monomer useful in the present invention can be an ethylenically unsaturated acetoacetoxy or acetoacetamide functional monomer, that is, a monomer having an ethylenic unsaturation and one or more acetoacetoxy or acetoacetamide functional group. Preferred acetoacetoxy or acetoacetamide functional monomers include acetoacetoxyalkyl (meth)acrylates such as acetoacetoxyethyl methacrylate (AAEM), acetoacetoxyethyl acrylate, acetoacetoxypropyl methacrylate, acetoacetoxybutyl methacrylate, and 2,3-di(acetoacetoxy)propyl methacrylate; allyl acetoacetate; acetoacetamides; or combinations thereof. The polyethylenimine coated polymeric beads may comprise, by weight based on the weight of the polyethylenimine coated polymeric beads, 35% or more, 38% or more, 40% or more, 42% or more, 45% or more, 48% or more, or even 50% or more, and at the same time, 75% or less, 72% or less, 70% or less, 68% or less, 65% or less, 62% or less, 60% or less, 58% or less, or even 55% or less of structural units of the acetoacetoxy or acetoacetamide functional monomer.

The polyethylenimine coated polymeric beads useful in the present invention may comprise structural units of one or more polyvinyl monomers. Polyvinyl monomers are monomers having two or more ethylenically unsaturated sites per molecule, for example, di-functional or tri-functional polyvinyl monomers, which are useful as crosslinkers to form a crosslinked polymer. A crosslinked polymer as used herein refers to a polymer polymerized from monomers containing a polyvinyl monomer. The polyvinyl monomer can be a polyvinyl aromatic monomer, a polyvinyl aliphatic monomer, or mixtures thereof. Examples of suitable polyvinyl monomers include polyvinylbenzene monomers such as divinylbenzene, trivinyl benzene, divinylnaphthalene, and diallyl phthalate; allyl (meth)acrylate; polyalkylene glycol di(meth)acrylate such as tripropylene glycol dimethacrylate, diethylene glycol dimethacrylate, ethylene glycol di(meth)acrylate, 1,6-hexanediol di(meth)acrylate, 1,3-butylene glycol dimethacrylate and 1,4-butylene glycol di(meth)acrylate; tri-functional (meth)acrylates such as trimethylolpropane trimethacrylate; or mixtures thereof. Preferred polyvinyl monomers include divinylbenzene, trimethylolpropane trimethacrylate, or mixtures thereof. The polyethylenimine coated polymeric beads may comprise, by weight based on the weight of the polyethylenimine coated polymeric beads, 25% or more, 28% or more, 30% or more, 32% or more, 35% or more, 38% or more, 40% or more, 42% or more, or even 45% or more, and at the same time, 65% or less, 62% or less, 60% or less, 58% or less, 55% or less, 52% or less, or even 50% or less of structural units of the polyvinyl monomer.

In some embodiments, the polyethylenimine coated polymeric beads comprise structural units of tri-functional (meth)acrylates such as trimethylolpropane trimethacrylate, in an amount of from 30% to 100%, for example, 31% or more, 32% or more, 33% or more, 34% or more, 35% or more, 38% or more, or even 40% or more, and at the same time, 95% or less, 90% or less, 85% or less, 80% or less, or even 75% or less, by weight based on the total weight of the structural units of the polyvinyl monomers.

The polyethylenimine coated polymeric beads useful in the present invention may also comprise structural units of one or more monovinyl aromatic monomers. Suitable monovinyl aromatic monomers may include, for example, styrene; α-substituted styrene such as methyl styrene, ethyl styrene, t-butyl styrene, and bromo styrene; vinyltoluenes; ethyl vinylbenzenes; vinylnaphthalenes; heterocyclic monomers such as vinylpyridine and 1-vinylimidazole; or mixtures thereof. Preferred monovinyl aromatic monomers include styrene, ethyl vinylbenzene, or mixtures thereof; and more preferably, styrene. Mixtures of monovinyl aromatic monomers can be employed. The polyethylenimine coated polymeric beads may comprise, by weight based on the weight of the polyethylenimine coated polymeric beads, from zero to 50% of structural units of the monovinyl aromatic monomer, for example, 30% or less, 20% or less, 10% or less, or even 5% or less of structural units of the monovinyl aromatic monomer.

The polyethylenimine coated polymeric beads useful in the present invention may further include structural units of one or more monovinyl aliphatic monomers. Said monovinyl aliphatic monomers expressly exclude the acetoacetoxy or acetoacetamide functional monomer described above. The monovinyl aliphatic monomer may include esters of (meth)acrylic acids, esters of itaconic acid, esters of maleic acid, (meth)acrylonitrile, α, β-ethylenically unsaturated carboxylic acids and/or their anhydrides; or mixtures thereof. Suitable α, β-ethylenically unsaturated carboxylic acids and/or their anhydrides may include (meth)acrylic anhydride, maleic anhydride, acrylamido-2-methylpropanesulfonic acid (AMPS), acrylic acid, methyl acrylic acid, crotonic acid, acyloxypropionic acid, maleic acid, fumaric acid, itaconic acid, or mixtures thereof. The esters of (meth)acrylic acids can be C₁-C₁₈-, C₄-C₁₂-, or C₈-C₁₀-alkyl esters of (meth)acrylic acid including, for example, methyl acrylate, ethyl acrylate, butyl acrylate, 2-ethylhexyl acrylate, decyl acrylate, lauryl acrylate, methyl methacrylate, butyl methacrylate, isodecyl methacrylate, 2-hyroxyethyl methacrylate, lauryl methacrylate, or mixtures thereof. Preferred monovinyl aliphatic monomers include methyl methacrylate, acrylonitrile, ethyl acrylate, 2-hyroxyethyl methacrylate, or mixtures thereof. The polyethylenimine coated polymeric beads may comprise, by weight based on the weight of the polyethylenimine coated polymeric beads, from zero to 40% of structural units of the monovinyl aliphatic monomer, for example, less than 30%, less than 20%, less than 10%, less than 5%, or less than 1% of structural units of the monovinyl aliphatic monomer. The polyethylenimine coated polymeric beads are preferably substantially free of structural units of the monovinyl aliphatic monomer.

In some embodiments, the polyethylenimine coated polymeric beads comprise, by weight based on the weight of the polyethylenimine coated polymeric beads, from 35% to 70% of structural units of the acetoacetoxy or acetoacetamide functional monomer, from 30% to 65% of structural units of the polyvinyl monomer, from 0 to 20% of structural units of the monovinyl aromatic monomer, and from 0 to 20% of structural units of the monovinyl aliphatic monomer. In a preferred embodiment, the polyethylenimine coated polymeric beads comprise, by weight based on the weight of the beads, from 40% to 70% of structural units of the acetoacetoxy or acetoacetamide functional monomer, from 30% to 60% of structural units of the polyvinyl monomer, and from 0 to 20% of structural units of the monovinyl aromatic monomer. In other embodiments, the polyethylenimine coated polymeric beads comprise structural units of the acetoacetoxy or acetoacetamide functional monomer and the rest being the polyvinyl monomer. Preferably, the polyethylenimine coated polymeric beads comprise, by weight based on the weight of the beads, from 35% to 70% or from 40% to 70% of structural units of the acetoacetoxy or acetoacetamide functional monomer, and the rest being the structural units of the polyvinyl monomer.

The polyethylenimine coated polymeric beads useful in the present invention may have a number average particle size of 340 μm or more, 350 μm or more, 360 μm or more, 370 μm or more, 380 μm or more, 390 μm or more, 400 μm or more, 410 μm or more, 420 μm or more, 430 μm or more, 440 μm or more, 450 μm or more, or even 460 μm or more, and at the same time, 680 μm or less, 650 μm or less, 630 μm or less, 600 μm or less, 550 μm or less, 500 μm or less, 480 μm or less, or even 470 μm or less. The number average particle size of the polyethylenimine coated polymeric beads can be determined according to the test method described in the Examples section below.

The polyethylenimine coated polymeric beads useful in the present invention may be porous crosslinked polymeric beads. The polyethylenimine coated polymeric beads may have a specific surface area of 20 m²/g or more, 25 m²/g or more, 30 m²/g or more, 40 m²/g or more, 45 m²/g or more, 50 m²/g or more, 60 m²/g or more, 70 m²/g or more, 80 m²/g or more, 85 m²/g or more, 90 m²/g or more, 100 m²/g or more, 105 m²/g or more, 110 m²/g or more, 115 m²/g or more, 120 m²/g or more, or even 130 m²/g or more. The polymeric bead may have a specific surface area of 400 m²/g or less, 380 m²/g or less, 350 m²/g or less, 340 m²/g or less, 300 m²/g or less, 250 m²/g or less, 200 m²/g or less, 150 m²/g or more, or even 140 m²/g or less. Preferably, the polyethylenimine coated polymeric beads have a specific surface area of from 20 to 100 m²/g, and more preferably from 50 to 100 m²/g. Values of the specific surface area per unit weight of the polyethylenimine coated polymeric beads (m² per gram of the polymeric beads) were determined by the nitrogen adsorption method in which dried and degassed samples were analyzed on an automatic volumetric sorption analyzer. The instrument works on the principle of measuring the volume of gaseous nitrogen adsorbed by a sample at a given nitrogen partial pressure. The volumes of gas adsorbed at various pressures are used in the BET (Brunauer—Emmett—Teller) model for calculation of the specific surface area of the sample.

The polyethylenimine useful in the present invention may have the following formula,

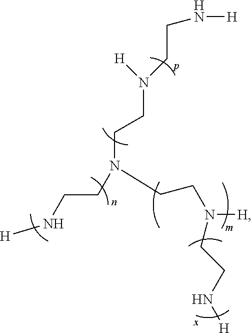

where n, m, p, and x are each independently an integer of from 0 to 1,000, provided that n+m+p+x>5. Preferably, n, m, p, and x are each independently an integer in the range of from 6 to 500, from 10 to 400, from 15 to 300, or from 20 to 200. Preferably, n+m+p+x is an integer in the range of from 6 to 4,000, from 10 to 1,000, or from 15 to 500.

The polyethylenimine useful in the present invention may have a number average molecular weight of 300 grams per mole (g/mol) or more, 400 g/mol or more, 500 g/mol or more, 800 g/mol or more, 1,000 g/mol or more, 1,200 g/mol or more, 1,500 g/mol or more, 1,700 g/mol or more, 2,000 g/mol or more, or even 2,200 g/mol or more, and at the same time, 1,000,000 g/mol or less, 750,000 g/mol or less, 500,000 g/mol or less, 250,000 g/mol or less, 100,000 g/mol or less, 50,000 g/mol or less, 25,000 g/mol or less, 10,000 g/mol or less, 8,000 g/mol or less, 5,000 g/mol or less, 4,000 g/mol or less, or even 3,000 g/mol or less. The molecular weight of polyethylenimine can be measured by Gel Permeation Chromatography (GPC) according to the test method described in the Examples section.

The polyethylenimine coated polymeric beads useful in the present invention can be prepared by (a) suspension polymerization of the monomers described above including the acetoacetoxy or acetoacetamide functional monomer and the polyvinyl monomer, and optionally, the monovinyl aromatic monomer and/or the monovinyl aliphatic monomers described above in the presence of a porogen to form uncoated polymeric beads (i.e., polymeric beads not coated by the polyethylenimine); and (b) contacting the uncoated polymeric beads from step (a) with the polyethylenimine to obtain the polyethylenimine coated polymeric beads. The polyethylenimine coated polymeric beads comprise the monomers in polymerized form, that is, structural units of the monomers comprising the acetoacetoxy or acetoacetamide functional monomer, the polyvinyl monomer, and optionally, the monovinyl aromatic monomer and/or the monovinyl aliphatic monomer. Total weight concentration of the monomers used for preparing the polyethylenimine coated polymeric beads is equal to 100%. For example, monomers used for preparing the polyethylenimine coated polymeric beads may comprise, by weight based on the total weight of monomers, from 35% to 75% of the acetoacetoxy or acetoacetamide functional monomer, and from 25% to 65% of the polyvinyl monomer.

Suspension polymerization for preparing the polymeric beads may be conducted in the presence of one or more porogens. The suspension polymerization is typically conducted by forming a suspension of monomers within an agitated, continuous suspending medium in the presence of one or more porogens, followed by polymerization of the monomers described above. Porogens are inert solvents that are suitable for forming pores and/or displacing polymer chains during polymerization. A porogen is one that dissolves the monomers being polymerized but does not dissolve the polymer obtained therefrom. Examples of suitable porogens include aliphatic hydrocarbon compounds such as heptane and octane, aromatic compounds such as benzene, toluene, and xylene, halogenated hydrocarbon compounds such as dichloroethane and chlorobenzene, and linear polymer compounds such as polystyrene. These compounds may be used alone or as a mixture of two or more thereof. Preferred porogens include diisobutyl ketone and toluene. The porogen may be used in an amount of from 10 to 500 parts, from 30 to 300 parts, or from 50 to 200 parts, per 100 parts by weight of total monomers for preparing the beads.

Suspension polymerization is well known to those skilled in the art and may comprise suspending droplets of the monomers and of the porogen in a medium in which neither are soluble. This may be accomplished by adding the monomers and the porogen with other additives to the suspending medium (preferably, water) which contains a stabilizer. The monomers may be first mixed with the porogen and other additions (e.g., a free radical initiator) to form an oil phase, and then the oil phase may be added into a water phase. The water phase may comprise a stabilizer, and optionally, additives such as sodium chloride, potassium chloride, sodium sulphate, and mixtures thereof; an inhibitor such as 2,2,6,6-tetramethylpiperidin-1-oxyl (“TEMPO”), 4-hydroxy-2,2,6,6-tetramethylpiperidin-1-oxyl (“4-Hydroxy-TEMPO”); and mixtures thereof. The monomers can be suspended as droplets often of diameter from 1 μm to 2,000 μm in water. The suspension polymerization may be conducted under nitrogen (N₂) atmosphere. The suspension polymerization is typically conducted under agitation at a speed of from 5 to 1,000 revolutions per minute (rpm), from 20 to 600 rpm, or from 50 to 300 rpm. Temperature suitable for suspension polymerization may be in the range of from 20° C. to 99° C. or in the range of from 60 to 90° C. Time duration for suspension polymerization may be in the range of from 1 to 30 hours, or in the range of from 3 to 20 hours.

The stabilizers useful in suspension polymerization are compounds useful for preventing agglomeration of monomer droplets. Examples of suitable stabilizers include polyvinyl alcohol (PVA), polyacrylic acid, polyvinyl pyrrolidone, polyalkylene oxide such as polyethylene glycol, gelatin, cellulose ethers such as hydroxyethyl cellulose, methyl cellulose, carboxymethyl methyl cellulose, hydroxypropyl methylcellulose (HPMC), and methyl hydroxyethyl cellulose (MHEC), poly(diallyldimethylammonium chloride) (PDAC), or mixtures thereof. Preferred suspension stabilizers include polyvinyl alcohol, gelatin, poly(diallyldimethylammonium chloride) and mixtures thereof. The stabilizer may be added in one shot or in at least two additions. The stabilizer may be used in an amount of from 0.01% to 3% or from 0.1% to 2%, by weight based on the total weight of the monomers.

Suspension polymerization may be conducted in the presence of a free radical initiator to initiate the polymerization. Examples of suitable free radical initiators include organic peroxides such as benzoyl peroxide, lauroyl peroxide, dioctanoyl peroxide and mixtures thereof, organic azo compounds including azobisisobutyronitrile such as 2,2′-azobisisobutyronitrile and 2,2′-azobis(2,4-dimethylvaleronitrile) and mixtures thereof. Preferred free radical initiators include benzoyl peroxide, lauroyl peroxide, and mixtures thereof. The free radical initiators may be used typically at a level of from 0.01% to 5% or from 0.1% to 2%, by weight based on the total weight of the monomers. After completion of suspension polymerization, the obtained polymer typically in the shape of beads (that is uncoated polymeric beads) may be isolated by filtration. To remove the excess water right after filtration, centrifugation can be used to separate beads with water. Solvents used in the suspension polymerization may be removed by distillation, by washing with other solvents followed by water wash, or combinations thereof. The resultant uncoated polymeric beads are then contacted with the polyethylenimine to obtain the polyethylenimine coated polymeric beads, where the acetoacetyl moieties in the uncoated polymeric beads can react with the polyethylenimine to form polymeric beads bearing enamine moieties. The polyethylenimine coated polymeric beads are polymeric beads bearing pendant enamine moieties resulting from the reaction of pendant acetoacetyl moieties with amine moieties in the polyethylenimine. The polyethylenimine coated polymeric beads may also bear acetoacetyl moieties and/or amine moieties. Contacting and/or reacting the polyethylenimine with the uncoated polymeric beads is preferably conducted at a temperature of from 25 to 100° C., from 60 to 80° C., or from 40 to 90° C. An aqueous solution of polyethylenimine is typically used, thus the process may further comprise separation of the obtained polyethylenimine coated polymeric beads from water, and optionally further exposing to drying. The polyethylenimine may be used in an amount of from 0.1% to 15%, from 0.5% to 12%, from 1% to 10%, from 1.5% to 8%, from 2% to 7%, or from 3% to 6%, by weight based on the weight of the uncoated polymeric beads.

The obtained polyethylenimine coated polymeric beads may be further processed and/or treated into various shapes. The polyethylenimine coated polymeric beads may also be treated or dried to further reduce odor, preferably in a fluidized bed. Drying the polymeric beads in a fluidized bed can be conducted at a temperature less than 100° C., for example, 95° C. or lower, 90° C. or lower, 85° C. or lower, 80° C. or lower, 75° C. or lower, 70° C. or lower, 65° C. or lower, or even 60° C. or lower. As compared to conventional treating approaches to remove odor such as solvent wash or vacuum drying, it is surprisingly found that treating or drying the polyethylenimine coated polymeric beads by a fluidized bed can efficiently reduce odor without compromising formaldehyde abatement properties of the polyethylenimine coated polymeric beads, which is also energy efficient without solvent waste. For example, the polyethylenimine coated polymeric beads desirably have an odor rating <2, and more preferably <1.5, while having a clean air delivery rate (CADR) higher than 85% of the CADR of activated carbon, preferably, higher than 90%, higher than 95%, higher than 100%, or even higher than 105% of that of activated carbon. CADR and odor properties may be measured according to the test method described in the Examples section below. The polyethylenimine coated polymeric beads in the active bead layer may be bonded to each other by the adhesive material.

In addition to the polyethylenimine coated polymeric beads, the active bead layer in the air filter medium may further comprise one or more antistatic agents. The term “antistatic agents” refers to a compound that reduces or eliminates static charge so that the beads will not agglomerate. Commonly used antistatic agents may include, for example, inorganic salts such as talc and aluminum silicate, surfactants, or mixtures thereof. Surfactants suitable as antistatic agents may include anionic compounds such as sodium nonylphenoxypropyl sulfonate, nonionic compounds such as monoglyceride stearate, and cationic compounds including quaternary amine salts such as stearic trimethyl quaternary ammonium hydrochloride. In addition, electrically conductive carbon blacks and metal particles can also be used as antistatic agents. The antistatic agent may be present in an amount of 0.01% or more, 0.05% or more, 0.1% or more, 0.15% or more, 0.2% or more, 0.25% or more, 0.3% or more, 0.35% or more, 0.4% or more, at the same time, 1.5% or less, 1.2% or less, 1.1% or less, 1.0% or less, 0.9% or less, 0.8% or less, 0.7% or less, 0.6% or less, or even 0.5% or less, by weight based on the weight of the polyethylenimine coated polymeric beads.

The active bead layer in the air filter medium may optionally comprise activated carbon. The activated carbon may be used in an amount without compromising formaldehyde abatement properties of the resultant air filter medium, for example, in an amount of less than 40%, less than 20%, less than 5%, less than 1.5%, less than 1%, less than 0.5%, less than 0.01%, or even zero, by weight based on the weight of the polyethylenimine coated polymeric beads.

The adhesive material useful in the present invention is used to bond the active bead layer to the first nonwoven fabric, the second nonwoven fabric, or both the first and second nonwoven fabrics. The adhesive material may form one or more adhesive layers between the active bead layer and the first and/or second nonwoven fabric. Suitable adhesive materials may include polyethylene copolymers such as polyethylene-co-vinyl acetate (EVA), polyurethane (PU), polyamide (PA), polyester (PET), polyolefins such as polyethylene and polypropylene, polystyrene copolymers such as styrene-butadiene copolymer (SBS) and styrene-isoprene copolymer (SIS), or mixtures thereof. Particularly suitable adhesive materials may include polyethylene-co-vinyl acetate, polyethylene, polyurethane, or mixtures thereof, preferably, polyethylene-co-vinyl acetate. Preferably, the adhesive material is a hot-melt adhesive. The hot-melt adhesive typically melts at an elevated temperature, for example, 60° C. or higher. The adhesive material may be used in an amount of 0.05% or more, 0.08% or more, 0.1% or more, 0.2% or more, 0.3% or more, 0.4% or more, 0.5% or more, 0.8% or more, or even 1% or more, and at the same time, 5% or less, 4% or less, 3% or less, or even 2% or less, by weight based on the weight of the polyethylenimine coated polymeric beads.

The first and/or second nonwoven fabrics in the air filter medium can be any fabrics that are commonly used in the air purifiers field, particularly those suitable for fabrication of high efficiency particulate air (HEPA) filters. The nonwoven fabric can be meltblown fabric or spunbonded fabric. The nonwoven fabric may be prepared from polyester, polyethylene, or polypropylene fibers.

The present invention also relates to a process for preparing the air filter medium of the present invention. The process may comprise (i) providing the first nonwoven fabric, preferably coated with the adhesive material; (ii) applying an admixture of the polyethylenimine coated polymeric beads and the antistatic agent to the first nonwoven fabric to form the active bead layer; (iii) spraying the adhesive material onto the active bead layer; and (iv) laminating the second nonwoven fabric to the first nonwoven fabric with the active bead layer residing between the first and the second nonwoven fabrics. The active bead layer is attached to the first and/or second nonwoven fabrics by the adhesive material, i.e., the active bead layer is bonded to the first nonwoven fabric, the second nonwoven fabric, or both the first and second nonwoven fabrics. Prior to mixing with the antistatic agent, the polyethylenimine coated polymeric beads are preferably dried in a fluidized bed at conditions described above for reducing odor of the beads, for example, at a temperature of 95° C. or lower. Steps (ii) and (iii) in the process can be repeated, e.g., applying the admixture forming an additional bead layer and then spraying the adhesive material on the additional bead layer, prior to the lamination step (iv), thus forming multiple active bead layers residing between and bonding to at least one of the first and the second nonwoven fabrics. Compositions for the admixtures for forming each of the multiple active bead layers can be the same or different and are as described above in the air filter medium section. The adhesive material may be heated to melt at 60° C. or higher, 80° C. or higher, 100° C. or higher, 120° C. or higher, 150° C. or higher, or even 160° C. or higher, prior to spray. The lamination of the second nonwoven fabric and the first nonwoven fabric with the active bead layer(s) residing therebetween can be conducted by hot lamination. Temperatures for lamination can be in the range of from 40° C. to 250° C., from 60° C. to 200° C., or from 100° C. to 180° C. The process of preparing the air filter medium may further comprise folding the obtained laminate from step (iv) into different shapes, e.g., corrugated shape.

The present invention also relates to a gas filter device comprising the air filter medium of the present invention. The gas filter devices may include, for example, filter beds, filter cartridges, tobacco smoke filters, high efficiency particulate air (HEPA) filters, ultralow penetration air (ULPA) filters, and automotive cabin air filters (CAFs), particularly HEPA filters. The gas filter device can be used in various applications such as air purifiers such as in-car air purifiers, and household air purifiers, and air conditioners.

The present invention also relates to a method of removing aldehydes from air containing aldehydes, comprising contacting the air filter medium of the present invention with air. The air filter medium causes aldehyde abatement (i.e., reduction). Examples of aldehydes include formaldehyde, acetaldehyde, acrolein, propionaldehyde and mixtures thereof. Without being bound by theory, it is believed that the polyethylenimine coated polymeric beads contain acetoacetyl moieties, enamine moieties, and amine moieties. The reaction of these moieties with aldehydes is irreversible (i.e., a chemical reaction) as compared to physically absorption of aldehydes by those conventional air filter media comprising activated carbon. The air filter medium may provide higher formaldehyde abatement efficiency as indicated by higher CADR than conventional air filter media comprising activated carbon. The air filter medium of the present invention can also provide good formaldehyde abatement capacity with rating of F4 in the cumulate clean mass (CCM) measurement. CADR and CCM may be evaluated according to the test methods described in the Examples section below.

### EXAMPLES

Some embodiments of the invention will now be described in the following Examples, wherein all parts and percentages are by weight unless otherwise specified.

Acetoacetoxyethyl methacrylate (AAEM) is available from Eastman Chemical Company.

Trimethylolpropane trimethacrylate (TRIM) used as a crosslinker, butyl acetate used as a porogen, and lauroyl peroxide (LPO) used as an initiator, are all available from Sinopharm Chemical Reagent Co., Ltd. (SCRC).

An aqueous solution of poly(diallyldimethylammonium chloride) (PDAC) (20% by weight), available from The Dow Chemical Company, is used as a stabilizer.

Methyl hydroxyethyl cellulose (MHEC), available from DuPont Company, is used as a stabilizer.

Polyethylenimine (PEI), available from SCRC, has a number average molecular weight as determined by GPC with polyethylene glycol standards of about 1800 g/mol.

Talc powder, available from SCRC, is used as an antistatic agent.

The following standard analytical equipment and methods are used in the Examples.

### Particle Size

The particle size of polymeric beads was determined using a Beckman Coulter RapidVue optical microscope. The particle size was determined by averaging particle size (diameter) of over 1,500 polymeric beads and the number average particle size was recorded.

### Specific Surface Area (BET Method)

Specific surface areas of polymeric beads were determined by nitrogen (N₂) adsorption—desorption isotherms on a Micrometric ASAP 2010 apparatus. Samples were dried at 50° C. overnight prior to adsorption studies. The volume of gas adsorbed to the surface of the polymeric beads was measured at the boiling point of nitrogen (−196° C.). The amount of adsorbed gas was correlated to the total surface area of the polymeric beads including pores on the surface. Specific surface area calculations were carried out using the BET method.

### Molecular Weight Measurement

GPC analysis was performed generally by Agilent 1200. A sample was dissolved in 0.1 mol/L sodium nitrate in deionized (DI) water with a concentration of about 4 mg/mL and then filtered through a 0.45 μm polyvinylidene fluoride (PVDF) filter prior to GPC analysis. The GPC analysis is conducted using the following conditions:

Column: One TSKgel guard column PWXL (6.0 mm*40 mm, 12 μm) and One TSK gel G3000 PWxl-CP columns (7.8 mm*30 cm, 7 μm) in tandem; column temperature: 25° C.; mobile phase: 0.1 mol/L sodium nitrate in DI water; flow rate: 0.8 mL/minute; injection volume: 100 L; detector: Agilent Refractive Index detector, 25° C.; and calibration curve: PL Polyethylene Glycol standards (Part No.: 2070-0100) with molecular weights ranging from 21300 to 106 g/mol, using polynom 3 fitness.

### Clean Air Delivery Rate (CADR) and Cumulate Clean Mass (CCM) Measurements for HEPA Filters

CADR of a test HEPA filter sample was first evaluated according to GB/T 18801-2015 method (Air Purifier) and recorded as CADR¹.

Then, the test HEPA filter sample was further evaluated by the CCM measurement according to GB/T 18801-2015. The CCM measurement is a measure of the cumulated formaldehyde that the HEPA can remove, which indicates the continuing air-cleaning power of a purifier. It is assessed by measuring the sheer volume of particulate matter and formaldehyde that can be efficiently filtered by the purifier before it starts to lose its overall efficiency over time. CCM, in milligram, represents the total mass of formaldehyde cumulatively handled when the clean air delivery rate (CADR²) of the air cleaner reduced to 50% of the initial value (CADR¹). Levels from F1 to F4 represent from low to high formaldehyde removing efficiency. The amount of formaldehyde in milligram (mg) for each level is,

F1: 300-600 mg; F2: 600-1000 mg, F3: 1000-1500 mg; F4: >1500 mg.

### In-House Measurement for CADR of Polymeric Beads

CADR measures the volume of clean air that is produced by a sample per minute. The in-house test of CADR of a sample was conducted in a mini-chamber system where formaldehyde was circulated in the system and passed through a testing tube. During the test, the formaldehyde concentration decreased gradually with testing time as formaldehyde was consumed by the sample. Detailed testing procedure was as follows:

A 4-liter glass chamber (available from Shanghai Hongjing instrument Co., Ltd., China) was used for the test and a plastic tube was connected to the outlet of the chamber. A formaldehyde detector (GT903-CH₂O available from Keernuo Co., Ltd., Shenzhen, China; formaldehyde detecting range: 0.01 mg/m³-13.4 mg/m³), a testing tube, an air pump, and a micro-flow controller were connected in sequence using plastic tubes, and finally connected to the inlet of the chamber to form a cycling mini-chamber system.

At the beginning of the test, an aliquot of a formaldehyde solution (about 400 ppm formaldehyde in a mixture of acetonitrile (ACN) and water) was injected into the glass chamber directly. Then the air pump started to circulate air inside the system at a flow rate of 500 mL/min to allow formaldehyde to equilibrate in the mini-chamber system. The initial formaldehyde concentration in the mini-chamber system was about 0.9 mg/m³ (milligram formaldehyde per cubic meter of air). Then a test sample (50 mg) was put in the testing tube quickly and formaldehyde-containing air was circulated in the system at a constant flow rate (500 mL/min). Formaldehyde concentrations at different time points were recorded using the formaldehyde detector. Formaldehyde concentration in the mini-chamber system, in mg/m³, as function of testing time was recorded. CADR values were then calculated using the equations below:

Q=60×k×V (i)

where Q is CADR value (m³/h), V is the volume of the mini-chamber (m³), and k is the decay constant (min⁻¹) determined according to equation (ii),

$$- k = \frac{( {\sum }_{i = 1}^{n} {t}_{i} {ln c}_{{t}_{i}} ) - \frac{1}{n} ( {\sum }_{i = 1}^{n} {t}_{i} ) ( {\sum }_{i = 1}^{n} {ln c}_{{t}_{i}} )}{( {\sum }_{i = 1}^{n} {{t}_{i}}^{2} ) - \frac{1}{n} {( {\sum }_{i = 1}^{n} {t}_{i} )}^{2}} , \qquad ( ii )$$

where k is the decay constant (min⁻¹); tᵢ is the sampling time (min); Incₜᵢ is the natural logarithms value of formaldehyde concentration of the sampling time of tᵢ; and n refers to the total number of sampling points.

Activated carbon and polymeric beads samples were evaluated based on the above procedure and CADR values were obtained.

### Odor Test

The odor of beads samples was evaluated via sensory evaluation by a no less than 3 panelists. The odor is rated on a sale of 1-6 from low to high according to the strength of odor and unpleasant degree as follows,

1: Not perceptible; 2: Perceptible, not disturbing. 3: Clearly perceptible, but not disturbing. 4: Disturbing. 5: Strongly disturbing; and 6: Not acceptable.

The average value of odor ratings of all the panelists was reported. The higher rating, the worse odor.

### In-House Coatability Test

An in-house testing method was used to simulate conditions in the step of spraying an adhesive material on polymeric beads during fabrication of HEPA filters, in order to determine if the polymeric beads can be homogeneously coated by the adhesive material. Pure air was supplied from a lab facility. A polytetrafluoroethylene (PTFE) tube (diameter: 4 mm) was used to connect the air source and a needle valve (WL91H-320P, DW6, from Fuyu Co., Ltd.) which was used to adjust the air flow rate. The outlet of the needle valve was connected to a flow meter (LZB-4WB, 0-7 liter/min, from Chanzhou Shuanghuan Co., Ltd., China) to measure the air flow rate, and the outlet of the flow meter was then connected to the bottom of a testing tube (180 mm length, 32 mm diameter).

Five grams (g) of polymeric beads sample were placed in the PTFE tube, which was set at vertical direction. The air flow was supplied to the bottom of the tube at different rates to observe the behaviors of the polymeric beads blown away in the testing tube. If the beads can't be blown away at an air flow rate of 0.7 L/min, it indicates the beads sample has good coatability suitable for the HEPA fabrication. Otherwise, if the beads can be blown away at a gas flow rate of 0.7 L/min, the beads sample has poor coatability and is not suitable for the HEPA fabrication.

### Preparation of PEI Coated Polymeric Beads

A 20 L, multi-pilot reactor equipped with a condenser, a Dean-Stark apparatus, a mechanical stirrer and inlet for N₂ was fed with DI water. Then stabilizers including MHEC (7.2 g) and PDAC (60 g, 20 wt % aqueous solution) were added into the reactor. The reactor was heated to 50° C. to dissolve MHEC until a clear solution was obtained. In a separate container, oil phase composition was prepared by mixing and agitating monomers (AAEM and TRIM), an initiator (LPO) and a porogen (butyl acetate) based on the oil phase composition listed in Table 1 below until a clear solution was obtained. The obtained oil phase composition was added into the reactor under mild agitation and the reactor was maintained at 50° C. for 30 min before it was heated to 75° C. The reaction proceeded for 7 hours. The reactor temperature was then ramped to 100° C. over 4 hours to distill butyl acetate. After that, the reactor was cooled to 80° C. and PEI was fed into the reactor within 30 min. The reactor was then cooled down to room temperature. Most of water in the reactor was filtered out through a stainless steel sieve with a mesh size of 325 mesh (or 44 μm). The obtained beads were kept in a filter sieve at room temperature for a few hours prior to drying in a conventional oven or in a fluidized bed. The CADR and odor properties of the obtained PEI coated polymeric beads were evaluated according to the test methods described above and results are summarized in Table 2.

TABLE 1
Compositions and conditions for preparing beads and properties of beads

| | Oil phase composition | | | | | Stirring | Drying conditions* | |
|---|---|---|---|---|---|---|---|---|
| | AAEM | TRIM | Butyl | LPO | PEI | rate | Temperature | Time |
| Samples | (g) | (g) | acetate (g) | (g) | (g) | (rpm) | (° C.) | (hour) |
| Beads A | 1500 | 1000 | 2500 | 25 | 150 | 150 | 95 | 16 |
| Beads B-1 | 1500 | 1000 | 2500 | 25 | 150 | 110 | 80 | 3 |
| Beads B-2 | 1500 | 1000 | 2500 | 25 | 150 | 110 | 60 | 4 |
| Beads C | 1500 | 1000 | 2500 | 25 | 150 | 80 | 80 | 3 |
| Beads D | 1500 | 1000 | 2500 | 25 | 150 | 60 | 60 | 4 |
| Beads E | 1500 | 1000 | 2500 | 25 | 150 | 145 | 95 | 16 |

*Drying was carried out in a fluidized bed, except PEI coated polymeric beads A and E were dried in a conventional oven.

As shown in Table 2, the PEI coated polymeric beads A, B-1, B-2, and C all showed better CADR properties than activated carbon. In contrast, the beads D with a number average particle size of 700 μm demonstrated lower CADR, as compared to activated carbon. Moreover, the beads A dried by a conventional oven showed stronger odor with rating of 3 than those beads dried by a fluidized bed (Beads B-1, B-2, C and D).

TABLE 2
Properties of Polymeric Beads

| Beads | Mass of beads | Number average particle | Specific surface area | CADR | Odor |
|---|---|---|---|---|---|
| sample | sample (g) | size of beads (μm) | (BET method) (m²/g) | ratio* | score |
| Beads A | 500 | 310 | 67 | 1.15 | 3 |
| Beads B-1 | 500 | 470 | 72 | 1.1 | 1 |
| Beads B-2 | 500 | 470 | 72 | 1.2 | 1 |
| Beads C | 500 | 630 | 71 | 1.1 | 1 |
| Beads D | 500 | 700 | 66 | 0.85 | 1 |
| Beads E | N.A. | 340 | 74 | N.A. | N.A. |

*CADR ratio refers to the ratio of CADR of polymeric beac s to CADR of activated carbon, as measured by the in-house CADR test method described above.

### Example (Ex 1) HEPA Filter Fabrication

Conventional production equipment for manufacturing activated carbon HEPA filters was used. A bead composition comprising the above obtained PEI coated polymeric beads B-1 and 0.5% by weight of talc powder, based on the weight of the PEI coated polymeric beads, were mixed and loaded into two feeding tanks with a discharging slot residing between the two tanks. Under the tanks, nonwoven cloth on a conveyor belt was moving horizontally at a pre-set speed. In another container, polyethylene-co-vinyl acetate hot-melt adhesive was heated to 160° C. to a liquid state. Then the admixture released from the discharging slot and sprayed (e.g., sprinkled) onto the moving nonwoven cloth, passing through a rotating roller. Next, the hot-melt adhesive liquid was sprayed onto the moving nonwoven cloth that was covered with a first layer of the bead composition. Following this, a second layer of the bead composition was further applied onto the first layer of the bead composition, followed by spraying the hot-melt adhesive. Finally, the coated cloth was laminated to another nonwoven cloth with the bead composition sandwiched between the two layers of the nonwoven cloth. The resultant laminate was corrugated into a folded structure and further processed into a HEPA filter.

### Comparative (Comp) Ex 1 HEPA Filter

The HEPA filter of Comp Ex 1 was prepared as in Ex 1, except activated carbon was used to replace the bead composition to form the active bead layer.

### Comp Ex 2 HEPA Filter

The HEPA filter of Comp Ex 2 was prepared as in Ex 1, except a bead composition only comprising the beads A (particle size: 310 μm) (no talc powder) was used to form the active bead layer.

### Comp Ex 3 HEPA Filter

The HEPA filter of Comp Ex 3 was prepared as in Ex 1, except a bead composition only comprising beads B-1 (no talc powder) was used to form the active bead layer. However, serious agglomeration of the beads was observed in the feeding tanks and on the roller, thus the beads failed to be coated by the hot-melt adhesive. Fabrication of the HEPA filter of Comp Ex 3 was stopped.

The obtained HEPA filters of Ex 1 and Comp Exs 1 and 2 were evaluated according to the test methods described above and results of properties are given in Table 3. During fabrication of the HEPA filter of Ex 1, the beads were coated by the hot-melt adhesive homogeneously and no leakage of the beads from the resultant HEPA filter was observed. The HEPA filter of Ex 1 showed higher formaldehyde (FA) abatement rate as indicated by higher CADR, as compared to those of Comp Exs 1 and 2. The HEPA filter of Ex 1 was rated F4 level in the FA abatement capacity test (CCM test). After the FA abatement capacity test, the CADR value of the HEPA filter of Ex 1 dropped less and was still much higher than that of Comp Exs 1 and 2.

Moreover, during fabrication of the HEPA filter of Comp Ex 2, some of the beads were blown away during coating with the hot-melt adhesive. It is also noticed that some of the beads were leaked out from the resultant fabricated HEPA filter. As a result, the distribution of the beads in the HEPA filter of Comp Ex 2 was not uniform.

TABLE 3
Properties of HEPA filters

| | Materials for | Mass of materials for | Number | | | |
|---|---|---|---|---|---|---|
| | forming active | forming active bead | average particle | CADR¹ | | CADR² |
| HEPA | bead layer | layer in each HEPA | size (μm) | (m³/h) | CCM¹ | (m³/h) |
| Comp Ex 1 | Activated carbon | 540 | N.A. | 190 | F4 | 99 |
| Comp Ex 2 | Beads A | 310 | 310 | 210 | F4 | 117 |
| Ex 1 | Beads B-1/0.5% | 540 | 470 | 287 | F4 | 243 |
| | talc powder | | | | | |

CADR¹ and CCM¹ were measured according to GB/T 18801-2015.
CADR² refers to CADR measured after CCM test

To mimic the hot-melt adhesive coating step during HEPA fabrication process, in-house coatability testing described above was used to evaluate the coatability of the PEI coated polymeric beads with an adhesive material. The beads A, beads B-1, and beads E with different particle size were evaluated. The test results showed that the beads A (particle size: 310 μm) were blown away at a gas flow rate of 0.7 L/min, while the beads E (particle size: 340 μm) and beads B-1 (particle size: 470 μm) were not blown away. It indicates the PEI coated polymeric beads with particle size of 340 μm or higher should have good coatability with an adhesive material and are suitable for HEPA fabrication.

What is claimed is:

1. An air filter medium comprising a first nonwoven fabric, a second nonwoven fabric, and at least one active bead layer residing between the first and second nonwoven fabrics; wherein the active bead layer is attached to at least one of the first and second nonwoven fabrics by an adhesive material;
wherein the active bead layer comprises an antistatic agent and polyethylenimine coated polymeric beads having a number average particle size of 340 μm to 680 μm and a specific surface area in the range of from 20 to 400 m²/g;
wherein the polyethylenimine coated polymeric beads comprise, by weight based on the weight of the polyethylenimine coated polymeric beads, from 35% to 75% of structural units of an acetoacetoxy or acetoacetamide functional monomer and from 25% to 65% of structural units of a polyvinyl monomer; and wherein the polyethylenimine has a number average molecular weight of 300 g/mol or more.

2. The air filter medium of claim 1, wherein the active bead layer comprises, by weight based on the weight of the polyethylenimine coated polymeric beads, from 0.01% to 1.5% of the antistatic agent.

3. The air filter medium of claim 1, wherein the polyethylenimine coated polymeric beads have a specific surface area in the range of from 20 to 100 m²/g.

4. The air filter medium of claim 1, wherein the acetoacetoxy or acetoacetamide functional monomer is selected from the group consisting of acetoacetoxyethyl methacrylate, acetoacetoxyethyl acrylate, acetoacetoxypropyl methacrylate, allyl acetoacetate, acetoacetoxybutyl methacrylate, 2,3-di(acetoacetoxy)propyl methacrylate, or mixtures thereof.

5. The air filter medium of claim 1, wherein the polyvinyl monomer is selected from the group consisting of divinylbenzene, trivinyl benzene, divinylnaphthalene, trimethylolpropane trimethacrylate, allyl (meth)acrylate, tripropylene glycol dimethacrylate, diethylene glycol dimethacrylate, ethylene glycol di(meth)acrylate, 1,6-hexanediol di(meth)acrylate, 1,3-butylene glycol dimethacrylate, 1,4-butylene glycol di(meth)acrylate, or mixtures thereof.

6. The air filter medium of claim 1, wherein the polyethylenimine coated polymeric beads comprise, by weight based on the weight of the polyethylenimine coated polymeric beads, from 40% to 70% of structural units of the acetoacetoxy or acetoacetamide functional monomer, from 30% to 60% of structural units of the polyvinyl monomer, and from 0 to 20% of structural units of a monovinyl aromatic monomer.

7. The air filter medium of claim 1, wherein the adhesive material is polyethylene-co-vinyl acetate.

8. The air filter medium of claim 1, wherein the antistatic agent is an inorganic salt.

9. A process for preparing the air filter medium of claim 1, comprising:
(i) providing a first nonwoven fabric;
(ii) applying an admixture of polyethylenimine coated polymeric beads and an antistatic agent to the first nonwoven fabric to form an active bead layer,
wherein the polyethylenimine coated polymeric beads with a number average particle size of 340 μm to 680 μm and a specific surface area in the range of from 20 to 400 m²/g comprise, by weight based on the weight of the polyethylenimine coated polymeric beads, from 35% to 75% of structural units of an acetoacetoxy or acetoacetamide functional monomer and from 25% to 65% of structural units of a polyvinyl monomer; and wherein the polyethylenimine has a number average molecular weight of 300 g/mol or more;
(iii) spraying an adhesive material onto the active bead layer; and
(iv) laminating a second nonwoven fabric to the first nonwoven fabric with the active bead layer residing therebetween.

10. The process of claim 9, wherein the polyethylenimine coated polymeric beads are dried in a fluidized bed prior to mixing with the antistatic agent.

11. The process of claim 10, wherein the polyethylenimine coated polymeric beads are dried at a temperature of 95° C. or lower.

12. The process of claim 11, further comprising repeating steps (ii) and (iii), prior to step (iv).
